(19) United States
(12) Patent Application Publication
(10) Pub. No.: US 2024/0273682 A1
(43) Pub. Date: Aug. 15, 2024

(54) CONDITIONAL DIFFUSION MODEL FOR DATA-TO-DATA TRANSLATION

(71) Applicant: NVIDIA Corporation, Santa Clara, CA (US)

(72) Inventors: Weili Nie, Sunnyvale, CA (US); Guan-Horng Liu, Marietta, GA (US); Arash Vahdat, San Mateo, CA (US); De-An Huang, Cupertino, CA (US); Anima Anandkumar, Pasadena, CA (US)

(21) Appl. No.: 18/431,527

(22) Filed: Feb. 2, 2024

Related U.S. Application Data
(60) Provisional application No. 63/444,835, filed on Feb. 10, 2023.

(51) Int. Cl. G06T 5/60; G06T 5/50

(52) U.S. Cl. CPC G06T 5/60; G06T 5/50

(57) ABSTRACT

Image restoration generally involves recovering a target clean image from a given image having noise, blurring, or other degraded features. Current image restoration solutions typically include a diffusion model that is trained for image restoration by a forward process that progressively diffuses data to noise, and then by learning in a reverse process to generate the data from the noise. However, the forward process relies on Gaussian noise to diffuse the original data, which has little or no structural information corresponding to the original data versus learning from the degraded image itself which is much more structurally informative compared to the random Gaussian noise. Similar problems also exist for other data-to-data translation tasks. The present disclosure trains a data translation conditional diffusion model from diffusion bridge(s) computed between a first version of the data and a second version of the data, which can yield a model that can provide interpretable generation, sampling efficiency, and reduced processing time.

### CLAIM OF PRIORITY

This application claims the benefit of U.S. Provisional Application No. 63/444,835 (Attorney Docket No. NVIDP1375+/23-SC-0133US01) titled “SYSTEM AND METHOD FOR IMAGE RESTORATION WITH IMAGE-TO-IMAGE SCHRODINGER BRIDGE,” filed Feb. 10, 2023, the entire contents of which is incorporated herein by reference.

### TECHNICAL FIELD

The present disclosure relates to generation of diffusion models for image restoration and other data-to-data translation tasks.

### BACKGROUND

Image restoration is a crucial problem in vision and image processing which generally involves restoring a given image to its original form or close to its original form. For example, an image restoration task may recover a target clean image from a given image having noise, blurring, or other degraded features. Image restoration has numerous practical applications, such as optimal filtering, data compression, adversarial defense, and safety-critical systems such as medicine and robotics.

Current image restoration solutions typically learn to sample the underlying (clean) data distribution (image) given the degraded distribution (image). In particular, a diffusion model will be trained for image restoration by a forward process that progressively diffuses data to noise, and then by learning in a reverse process to generate the data from the noise. However, the reverse denoising process always starts from Gaussian noise, which has little or no structural information corresponding to the original data. Thus, these diffusion models are not trained to learn from the degraded images themselves, which are much more structurally informative compared to the random Gaussian noise.

Similar problems also exist for other image-to-image translation tasks, and for that matter even for translation tasks involving other types of data.

There is a need for addressing these issues and/or other issues associated with the prior art. For example, there is a need to train a conditional diffusion model for data-to-data translation (e.g. image restoration) from the diffusion bridge(s) existing between different versions of the data.

### SUMMARY

A method, computer readable medium, and system are disclosed for generating a conditional diffusion model for data-to-data translation. One or more diffusion bridges between a first version of data and a second version of the data are computed. The one or more diffusion bridges are used to train a conditional diffusion model to perform data-to-data translation.

### BRIEF DESCRIPTION OF THE DRAWINGS

FIG. 1 illustrates a flowchart of a method for generating a conditional diffusion model for data-to-data translation, in accordance with an embodiment.

FIG. 2 illustrates a plurality of diffusion bridges computed between degraded and clean versions of an image and on which a conditional diffusion model is trained to perform image-to-image translation, in accordance with an embodiment.

FIG. 3 illustrates an algorithm for training a conditional diffusion model to perform data-to-data translation using a plurality of diffusion bridges computed between different versions of data, in accordance with an embodiment.

FIG. 4 illustrates an algorithm for using the conditional diffusion model trained according to the algorithm in FIG. 3, in accordance with an embodiment.

FIG. 5 illustrates a block diagram of a system for using a data restoration conditional diffusion model, in accordance with an embodiment.

FIG. 6 illustrates exemplary input and output of a conditional diffusion model conditional diffusion model configured for image restoration, in accordance with an embodiment.

FIG. 7A illustrates inference and/or training logic, according to at least one embodiment;

FIG. 7B illustrates inference and/or training logic, according to at least one embodiment;

FIG. 8 illustrates training and deployment of a neural network, according to at least one embodiment;

FIG. 9 illustrates an example data center system, according to at least one embodiment.

### DETAILED DESCRIPTION

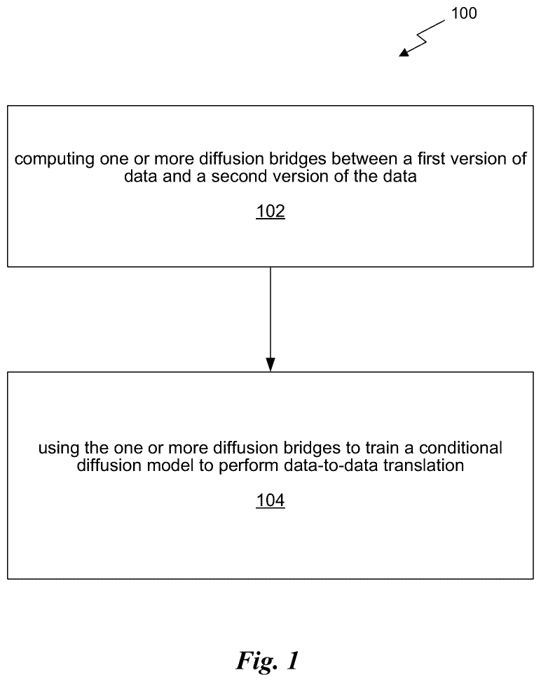

FIG. 1 illustrates a flowchart of a method 100 for generating a conditional diffusion model for data-to-data translation, in accordance with an embodiment. The method 100 may be performed by a device, which may be comprised of a processing unit, a program, custom circuitry, or a combination thereof, in an embodiment. In another embodiment, a system comprised of a non-transitory memory storage comprising instructions, and one or more processors in communication with the memory, may execute the instructions to perform the method 100. In another embodiment, a non-transitory computer-readable media may store computer instructions which when executed by one or more processors of a device cause the device to perform the method 100.

In operation 102, one or more diffusion bridges between a first version of data and a second version of the data are computed. With respect to the present description, the data refers to any computer readable information capable of being processed in accordance with the present method 100. In various embodiments, the data may be audio, video, an image, etc.

In any case, the data is represented in both a first version and a second version. The first and second versions refer to different versions (e.g. distributions, etc.) of the same data. The first version and the second version of the data may be supplied as training data. For example, the training data may include pairs of data versions to use for training a conditional diffusion model as described in more detail below.

In an embodiment, the first version of the data may be a degraded version of the data and the second version of the data may be a clean target version of the data. The clean target version may be more complete than the degraded version. For example, the clean target version may have a threshold level of improvement (e.g. completeness, etc.) than the degraded version.

In the example where the data is an image, the first version of the image may be a degraded version of the image and the second version of the image may be a clean target version of the image. In an embodiment, the degraded version of the image may have a lower resolution than the clean target version of the image. In another embodiment, the degraded version of the image may be a corrupted version of the clean target version of the image. In yet another embodiment, the degraded version of the image may include more blurring than the clean target version of the image.

In one exemplary embodiment, the degraded version of the image may be captured by a camera. For example, the camera may be a component of an autonomous driving system. In this example, the clean target version of the image may be a manually or procedurally improved version of the image captured by the camera.

As mentioned, one or more diffusion bridges are computed between the first version of data and the second version of the data. A diffusion bridge refers to a model that defines transport between two data distributions (e.g. data versions). In an embodiment, one or more of the diffusion bridges may be a diffusion model. In an embodiment, one or more of the diffusion bridges may be diffusion bridge may be nonlinear. In other embodiments, which will be described in more detail below and with reference to the subsequent figures, the one or more diffusion bridges may be tractable, interpretable, and/or efficient.

In an embodiment, the one or more diffusion bridges may correspond to one or more time steps existing between the first version of the data and the second version of the data. Each timestep may in turn correspond to a different version of the data. Accordingly, incremental diffusion bridges between the first version of the data and the second version of the data may be computed. The one or more diffusion bridges may accordingly incrementally transform the first version of the data to the second version of the data (e.g. with each diffusion bridge accordingly representing an incrementally improved version of the data, starting with the first version of the data, until the second version of the data is achieved). A preset number of diffusion bridges may be computed between the first and second versions of the data (i.e. to bridge the first version of the image to the second version), in an embodiment.

In operation 104, the one or more diffusion bridges are used to train a conditional diffusion model to perform data-to-data translation. The conditional diffusion model is a machine learning model that can generate data from noise. In the present description, the conditional diffusion model learns to generate the second version of the data from the first version of the data, using the one or more diffusion bridges. In an embodiment, the one or more diffusion bridges may be used to train a score function to perform the data-to-data translation.

For example, instead of forming a noisy version of the data by gradually adding random noise to the second version (e.g. clean target) of the data in a traditional reverse diffusion process, and then learning in a forward diffusion process to generate the second version of the data from the noisy version, the present operation 104 may use the diffusion bridge(s) computed directly between the first version of the data and the second version of the data to learn in a forward diffusion process to generate the second version of the data from the first version of the data. Since the first version of the data is more structurally informative to the second version of the data than a randomly noisy version would be, the trained conditional diffusion model may trained more efficiently than if trained using the randomly noisy version. In other words, it is more efficient to learn the direct mappings between the first and second versions of the data given that their differences are already limited.

As mentioned, the conditional diffusion model is trained specifically to perform data-to-data translation. This data may be in any desired domain, such as an image domain, audio domain, etc. In any case, the data-to-data translation refers to generating a target version of data from an input version of the data.

In an embodiment, the data-to-data translation may be a data restoration task (e.g. restoring a target version of data from an input version of the data). In an embodiment, the data-to-data translation may be an image-to-image translation, where for example the image-to-image translation is an image restoration task. The image restoration task may refer to inpainting, super-resolution, deblurring, etc.

The data-to-data translation may have various applications. In an embodiment, the conditional diffusion model may be trained to perform the data-to-data translation for a data compression application. In another embodiment, the conditional diffusion model may be trained to perform the data-to-data translation for a robotics application. In another embodiment, the conditional diffusion model may be trained to perform the data-to-data translation for an autonomous driving application.

In one exemplary implementation of the method 100, a pair of images in training data are accessed. The pair of images includes a clean version of an image and a degraded version of the same image. As mentioned, this pair of images is included in training data, and thus may be generated, or otherwise selected, by a human for the purpose of training a machine learning model. One or more diffusion bridges that incrementally transform the degraded version of the image to the clean version of the image are then computed. Each diffusion bridge may accordingly represent an incrementally improved version of the image, starting with the degraded version of the image, until the clean version of the image is achieved. A preset number of diffusion bridges may be computed between the clean and degraded versions of the image (i.e. to bridge the degraded version of the image to the clean version of the image), in an embodiment. Further, the degraded version of the image, the clean version of the image, and the one or more diffusion bridges are used to train a conditional diffusion model to improve degraded images, such that, given any input image, the trained conditional diffusion model outputs a corresponding image with improved quality.

In an embodiment of this exemplary implementation, the degraded version of the image may include more blurring than the clean version of the image. In this case, the conditional diffusion model may be trained to reduce blur in a given image. In another embodiment of this exemplary implementation, the clean version of the image may be a complete image and the degraded version of the image may include areas that are missing, such that that the conditional diffusion model may be trained to complete missing areas of a given image. In yet another embodiment of this exemplary implementation, the conditional diffusion model may be trained to improve a quality of a given photograph (e.g. which includes blurring, low resolution, missing areas, etc.).

Further embodiments will now be provided in the description of the subsequent figures. It should be noted that the embodiments disclosed herein with reference to the method 100 of FIG. 1 may apply to and/or be used in combination with any of the embodiments of the remaining figures below.

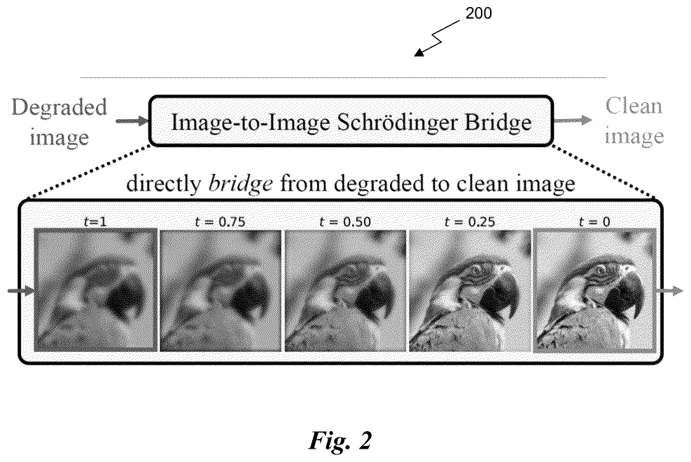

FIG. 2 illustrates a pictorial flow 200 of the computation of a plurality of diffusion bridges between degraded and clean versions of an image on which a conditional diffusion model is trained to perform image-to-image translation, in accordance with an embodiment. The flow 200 may be carried out in accordance with the method 100 of FIG. 1, in an embodiment. Further, the descriptions and/or definitions given above may equally apply to the present embodiment.

As shown, diffusion bridges are computed over a plurality of timesteps t=0 to t=1 for given degraded and clean versions of an image. The diffusion bridges indicate incremental versions of the image existing between the degraded and clean versions of the image. A conditional diffusion model is then trained to perform image-to-image translation, using the diffusion bridges.

In the present example, the conditional diffusion model is illustrated as an Image-to-Image Schrodinger Bridge. Thus, rather than generating images from random noise as in prior diffusion models, the present flow 200 directly learns the diffusion bridges between degraded and clean distributions, yielding more interpretable generation effective for image restoration. It should be noted that while the flow 200 is described with respect to images in particular, the flow 200 may equally be applied to other types of data for other data-to-data translation tasks.

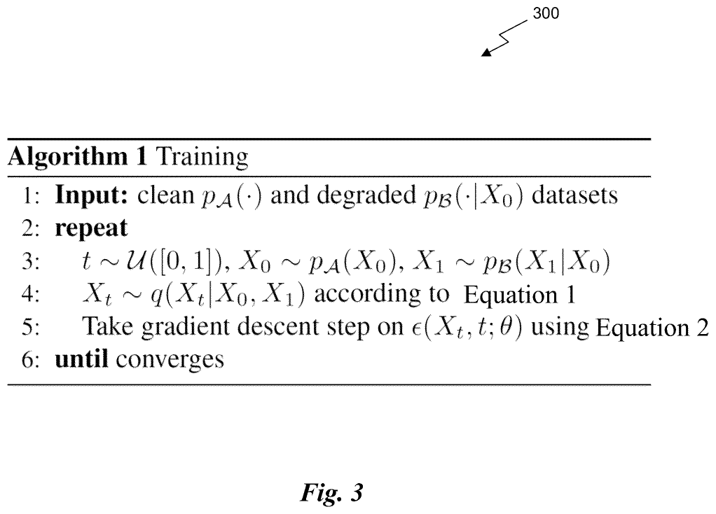

FIG. 3 illustrates an algorithm 300 for training a conditional diffusion model to perform data-to-data translation using a plurality of diffusion bridges computed between different versions of data, in accordance with an embodiment. The algorithm 300 is one exemplary implementation of the method 100 of FIG. 1.

The algorithm 300 assumes pair information (i.e. a boundary pair) is available during training, denoted as p(X₀, X₁)=p_{A}(X₀)p_{B}(X₁|X₀), where X₁ is the clean version of the data and X₀ is the degraded version of the data, and where p_{A}(X₀) is the data distribution of clean data and p_{B}(X₁|X₀) is the data distribution of degraded data.

Training scalable diffusion models requires efficient computation of Xₜ, where Xₜ is data version at timestep t. In an embodiment, during training when (X₀, X₁) are available from p_{A}(X₀) and p_{B}(X₁|X₀), Xₜ can be sampled directly from the following Equation 1 without solving any nonlinear diffusion:

$$q ( {X}_{t} \vert {X}_{0} , {X}_{1} ) = ( {X}_{t} ; {μ}_{t} ( {X}_{0} , {X}_{1} ) , {Σ}_{t} ) , \qquad Equation 1$$

$${μ}_{t} = \frac{{\overline{σ}}_{t}^{2}}{{\overline{σ}}_{t}^{2} + {σ}_{t}^{2}} {X}_{0} + \frac{{σ}_{t}^{2}}{{\overline{σ}}_{t}^{2} + {σ}_{t}^{2}} {X}_{1} ,$$

$${Σ}_{t} = \frac{{σ}_{t}^{2} {\overline{σ}}_{t}^{2}}{{\overline{σ}}_{t}^{2} + {σ}_{t}^{2}} \cdot I$$

where σₜ²:=∫₀^{t}β_{τ}dτ and σ̅ₜ²:=∫ₜ¹β_{τ}dτ are variances accumulated from either sides.

The network parameterization is ξ(Xₜ, t; θ), and the training objective can be defined per Equation 2.

$$‖ ϵ ( {X}_{t} , t , θ ) - \frac{{X}_{t} - {X}_{0}}{{σ}_{t}} ‖ \qquad Equation 2$$

The training algorithm 300 then includes, for given clean and degraded data sets as described above, repeating for each of a plurality of timesteps the computation of the data version at the time step (according to Equation 1) and then taking of a gradient descent step using the training objective (according to Equation 2), until convergence.

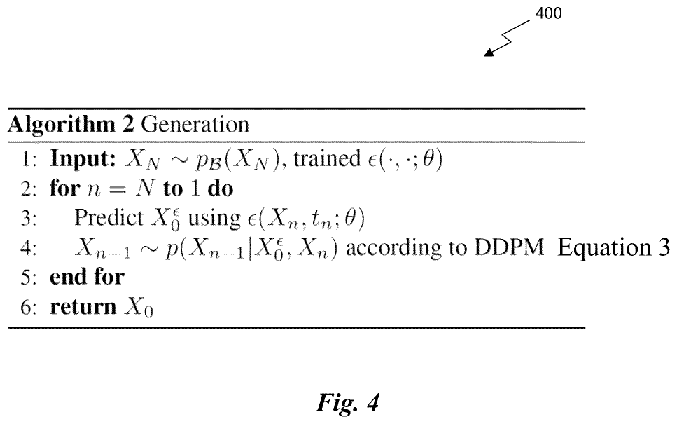

FIG. 4 illustrates an algorithm 400 for using the conditional diffusion model trained according to the algorithm in FIG. 3, in accordance with an embodiment. In particular, the conditional diffusion model generates a clean version of data for a given degraded version of data.

Input to the run-time generation algorithm 400 is a degraded version of data and the conditional diffusion model trained according to the algorithm 300 of FIG. 3. The run-time generation algorithm 400 uses the conditional diffusion model to predict the clean version of the data from the degraded version of the data.

As shown, incremental versions of the data are predicted from the degraded version of the data per time step until the clean version of the data is generated. The run-time generation algorithm 400 employs a Denoising Diffusion Probabilistic Model (DDPM) which provides recursive posterior sampling per Equation 3.

$${X}_{n} ∼ p ( {X}_{n} \vert {X}_{0}^{ϵ} , {X}_{n + 1} ) , \qquad Equation 3$$

$${X}_{N} ∼ ( 0 , I )$$

### Simulation-Free Optimal Transport

In an embodiment, the conditional diffusion model can be instantiated as a simulation-free optimal transport by removing the noise injected into Xₜ in both training and generation (the lines 4 in Algorithms 1 and 2).

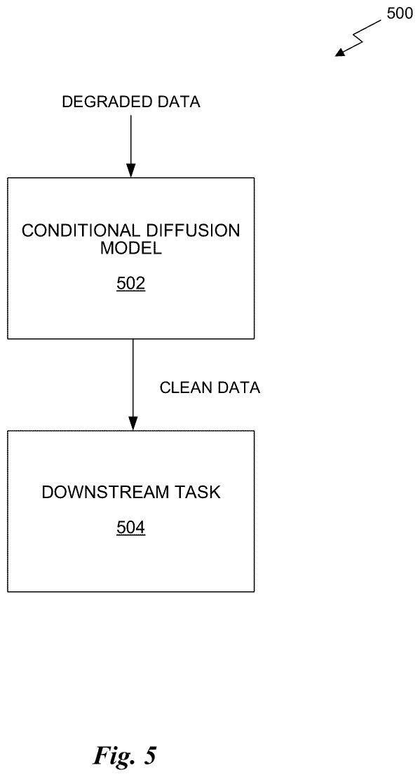

FIG. 5 illustrates a block diagram of a system 500 for using a data restoration conditional diffusion model, in accordance with an embodiment.

As shown, degraded data is input to conditional diffusion model 502. In the context of the present embodiment, the conditional diffusion model is trained for performing data restoration. In embodiments, the data restoration conditional diffusion model may be trained in accordance with the method 100 of FIG. 1 and/or the algorithm 300 of FIG. 3.

The conditional diffusion model 502 processes the degraded data to generate clean data. The clean data refers to a clean version of the degraded data. For example, the clean data may be an at least partially restored version of the degraded data.

The clean data is output to a downstream task 504. The downstream task 504 refers to any application or process that is configured to use the clean data for some purpose. Thus, in an embodiment, the conditional diffusion model 502 may execute independently of the downstream task 504. For example, the conditional diffusion model 502 may be located in the cloud and the downstream task 504 may be located at a local device or at another location in the cloud.

In one embodiment, the downstream task 504 may be a user interface-based application that presents the clean data to a user. In another embodiment, the downstream task 504 may be an autonomous driving application, where for example a degraded image captured by a camera on an autonomous driving vehicle is restored by the conditional diffusion model 502 and then output to the autonomous driving application for use in making autonomous driving decisions.

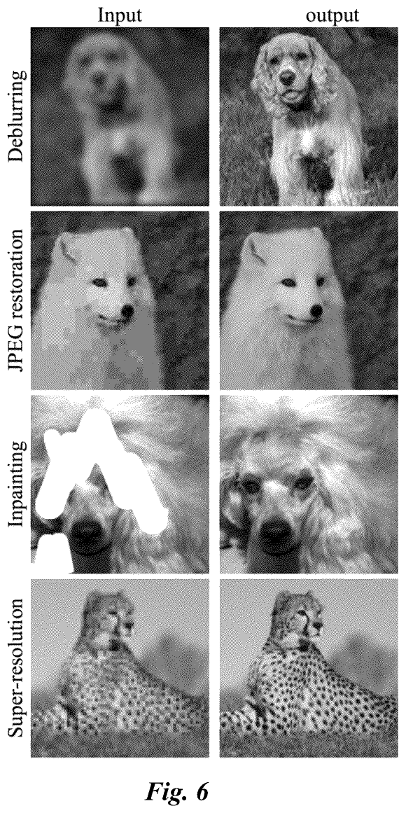

FIG. 6 illustrates exemplary input and output of a conditional diffusion model configured for image restoration, in accordance with an embodiment. As shown, the image restoration is illustrated for various specific applications, including deblurring, JPEG restoration, inpainting, and super-resolution. In each application, the input is a degraded version of an image from which the conditional diffusion model generates a clean, or restored, version of the image.

### Machine Learning

Deep neural networks (DNNs), including deep learning models, developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions. Inferencing is less compute-intensive than training, being a latency-sensitive process where a trained neural network is applied to new inputs it has not seen before to classify images, translate speech, and generally infer new information.

### Inference and Training Logic

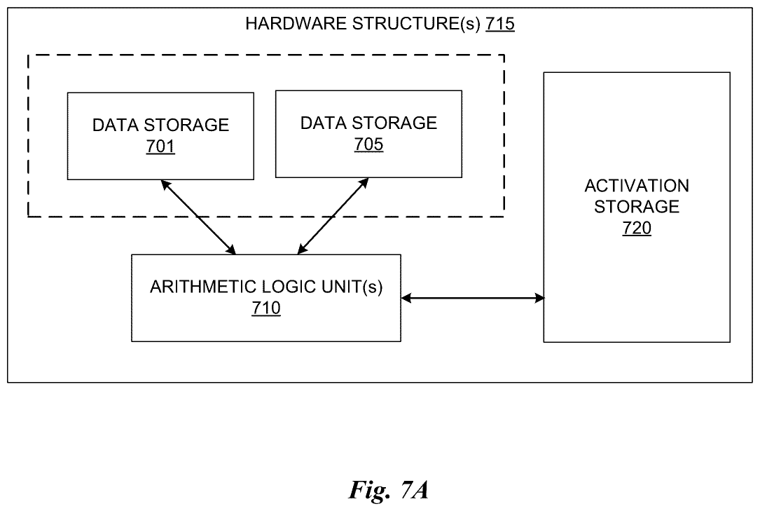

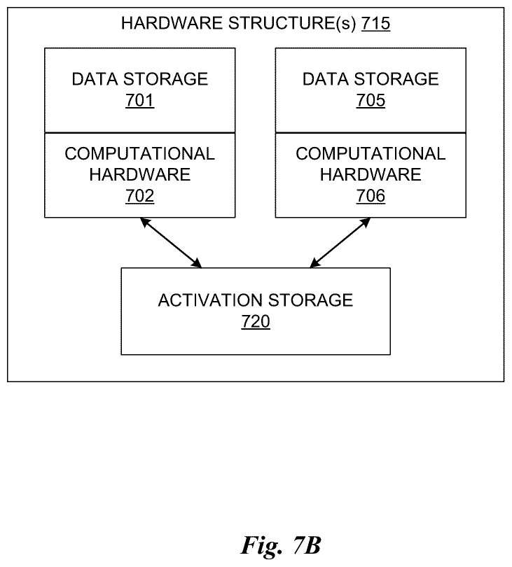

As noted above, a deep learning or neural learning system needs to be trained to generate inferences from input data. Details regarding inference and/or training logic 715 for a deep learning or neural learning system are provided below in conjunction with FIGS. 7A and/or 7B.

In at least one embodiment, inference and/or training logic 715 may include, without limitation, a data storage 701 to store forward and/or output weight and/or input/output data corresponding to neurons or layers of a neural network trained and/or used for inferencing in aspects of one or more embodiments. In at least one embodiment data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of data storage 701 may be included with other on-chip or off-chip data storage, including a processor's L1, L2, or L3 cache or system memory.

In at least one embodiment, any portion of data storage 701 may be internal or external to one or more processors or other hardware logic devices or circuits. In at least one embodiment, data storage 701 may be cache memory, dynamic randomly addressable memory (“DRAM”), static randomly addressable memory (“SRAM”), non-volatile memory (e.g., Flash memory), or other storage. In at least one embodiment, choice of whether data storage 701 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a data storage 705 to store backward and/or output weight and/or input/output data corresponding to neurons or layers of a neural network trained and/or used for inferencing in aspects of one or more embodiments. In at least one embodiment, data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, any portion of data storage 705 may be included with other on-chip or off-chip data storage, including a processor's L1, L2, or L3 cache or system memory. In at least one embodiment, any portion of data storage 705 may be internal or external to on one or more processors or other hardware logic devices or circuits. In at least one embodiment, data storage 705 may be cache memory, DRAM, SRAM, non-volatile memory (e.g., Flash memory), or other storage. In at least one embodiment, choice of whether data storage 705 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, data storage 701 and data storage 705 may be separate storage structures. In at least one embodiment, data storage 701 and data storage 705 may be same storage structure. In at least one embodiment, data storage 701 and data storage 705 may be partially same storage structure and partially separate storage structures. In at least one embodiment, any portion of data storage 701 and data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710 to perform logical and/or mathematical operations based, at least in part on, or indicated by, training and/or inference code, result of which may result in activations (e.g., output values from layers or neurons within a neural network) stored in an activation storage 720 that are functions of input/output and/or weight parameter data stored in data storage 701 and/or data storage 705. In at least one embodiment, activations stored in activation storage 720 are generated according to linear algebraic and or matrix-based mathematics performed by ALU(s) 710 in response to performing instructions or other code, wherein weight values stored in data storage 705 and/or data 701 are used as operands along with other values, such as bias values, gradient information, momentum values, or other parameters or hyperparameters, any or all of which may be stored in data storage 705 or data storage 701 or another storage on or off-chip. In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALUs 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, data storage 701, data storage 705, and activation storage 720 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., Flash memory), or other storage. In at least one embodiment, activation storage 720 may be completely or partially within or external to one or more processors or other logical circuits. In at least one embodiment, choice of whether activation storage 720 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 715 illustrated in FIG. 7A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, data storage 701 and data storage 705, which may be used to store weight values and/or other information, including bias values, gradient information, momentum values, and/or other parameter or hyperparameter information. In at least one embodiment illustrated in FIG. 7B, each of data storage 701 and data storage 705 is associated with a dedicated computational resource, such as computational hardware 702 and computational hardware 706, respectively. In at least one embodiment, each of computational hardware 706 comprises one or more ALUs that perform mathematical functions, such as linear algebraic functions, only on information stored in data storage 701 and data storage 705, respectively, result of which is stored in activation storage 720.

In at least one embodiment, each of data storage 701 and 705 and corresponding computational hardware 702 and 706, respectively, correspond to different layers of a neural network, such that resulting activation from one “storage/computational pair 701/702” of data storage 701 and computational hardware 702 is provided as an input to next “storage/computational pair 705/706” of data storage 705 and computational hardware 706, in order to mirror conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage computation pairs 701/702 and 705/706 may be included in inference and/or training logic 715.

### Neural Network Training and Deployment

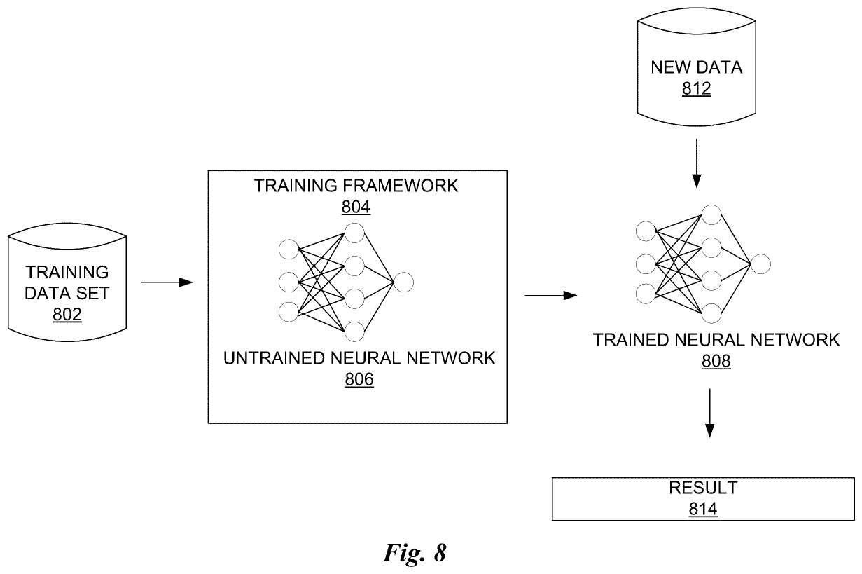

FIG. 8 illustrates another embodiment for training and deployment of a deep neural network. In at least one embodiment, untrained neural network 806 is trained using a training dataset 802. In at least one embodiment, training framework 804 is a PyTorch framework, whereas in other embodiments, training framework 804 is a Tensorflow, Boost, Caffe, Microsoft Cognitive Toolkit/CNTK, MXNet, Chainer, Keras, Deeplearning4j, or other training framework. In at least one embodiment training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having known output and the output of the neural network is manually graded. In at least one embodiment, untrained neural network 806 is trained in a supervised manner processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on known input data, such as new data 812. In at least one embodiment, training framework 804 trains untrained neural network 806 repeatedly while adjust weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, wherein untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map, which is a type of trained neural network 808 capable of performing operations useful in reducing dimensionality of new data 812. In at least one embodiment, unsupervised training can also be used to perform anomaly detection, which allows identification of data points in a new dataset 812 that deviate from normal patterns of new dataset 812.

In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new data 812 without forgetting knowledge instilled within network during initial training.

### Data Center

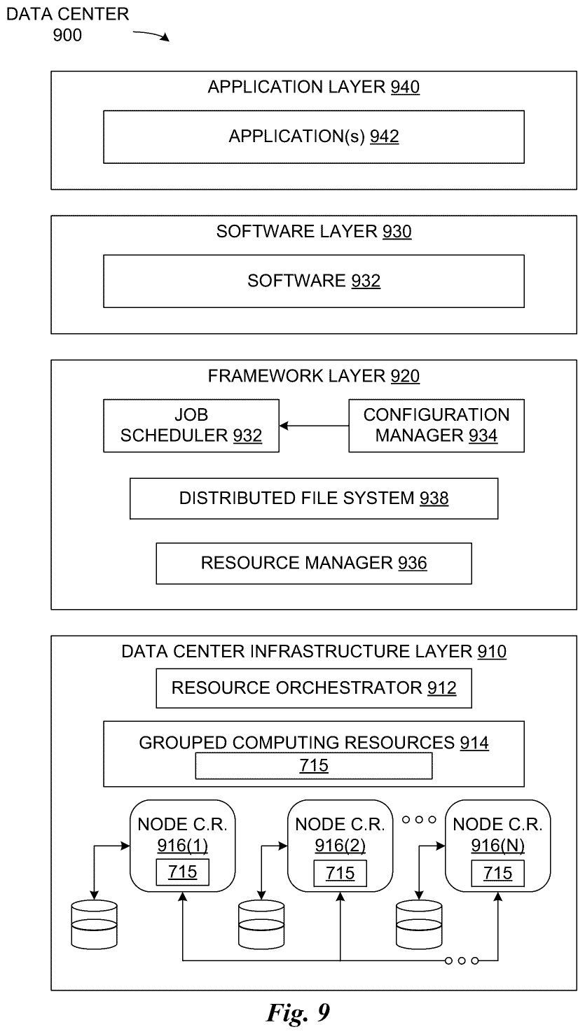

FIG. 9 illustrates an example data center 900, in which at least one embodiment may be used. In at least one embodiment, data center 900 includes a data center infrastructure layer 910, a framework layer 920, a software layer 930 and an application layer 940.

In at least one embodiment, as shown in FIG. 9, data center infrastructure layer 910 may include a resource orchestrator 912, grouped computing resources 914, and node computing resources (“node C.R.s”) 916(1)-916(N), where “N” represents any whole, positive integer. In at least one embodiment, node C.R.s 916(1)-916(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 916(1)-916(N) may be a server having one or more of above-mentioned computing resources.

In at least one embodiment, grouped computing resources 914 may include separate groupings of node C.R.s housed within one or more racks (not shown), or many racks housed in data centers at various geographical locations (also not shown). Separate groupings of node C.R.s within grouped computing resources 914 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 922 may configure or otherwise control one or more node C.R.s 916(1)-916(N) and/or grouped computing resources 914. In at least one embodiment, resource orchestrator 922 may include a software design infrastructure (“SDI”) management entity for data center 900. In at least one embodiment, resource orchestrator may include hardware, software or some combination thereof.

In at least one embodiment, as shown in FIG. 9, framework layer 920 includes a job scheduler 932, a configuration manager 934, a resource manager 936 and a distributed file system 938. In at least one embodiment, framework layer 920 may include a framework to support software 932 of software layer 930 and/or one or more application(s) 942 of application layer 940. In at least one embodiment, software 932 or application(s) 942 may respectively include web-based service software or applications, such as those provided by Amazon Web Services, Google Cloud and Microsoft Azure. In at least one embodiment, framework layer 920 may be, but is not limited to, a type of free and open-source software web application framework such as Apache Spark™ (hereinafter “Spark”) that may utilize distributed file system 938 for large-scale data processing (e.g., “big data”). In at least one embodiment, job scheduler 932 may include a Spark driver to facilitate scheduling of workloads supported by various layers of data center 900. In at least one embodiment, configuration manager 934 may be capable of configuring different layers such as software layer 930 and framework layer 920 including Spark and distributed file system 938 for supporting large-scale data processing. In at least one embodiment, resource manager 936 may be capable of managing clustered or grouped computing resources mapped to or allocated for support of distributed file system 938 and job scheduler 932. In at least one embodiment, clustered or grouped computing resources may include grouped computing resource 914 at data center infrastructure layer 910. In at least one embodiment, resource manager 936 may coordinate with resource orchestrator 912 to manage these mapped or allocated computing resources.

In at least one embodiment, software 932 included in software layer 930 may include software used by at least portions of node C.R.s 916(1)-916(N), grouped computing resources 914, and/or distributed file system 938 of framework layer 920. one or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-916(N), grouped computing resources 914, and/or distributed file system 938 of framework layer 920. one or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 934, resource manager 936, and resource orchestrator 912 may implement any number and type of self-modifying actions based on any amount and type of data acquired in any technically feasible fashion. In at least one embodiment, self-modifying actions may relieve a data center operator of data center 900 from making possibly bad configuration decisions and possibly avoiding underutilized and/or poor performing portions of a data center.

In at least one embodiment, data center 900 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 900. In at least one embodiment, trained machine learning models corresponding to one or more neural networks may be used to infer or predict information using resources described above with respect to data center 900 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 715 are used to perform inferencing and/or training operations associated with one or more embodiments. In at least one embodiment, inference and/or training logic 715 may be used in system FIG. 9 for inferencing or predicting operations based, at least in part, on weight parameters calculated using neural network training operations, neural network functions and/or architectures, or neural network use cases described herein.

As described herein, a method, computer readable medium, and system are disclosed for a conditional diffusion model for data-to-data translation. In accordance with FIGS. 1-6, embodiments may provide a conditional diffusion model usable for performing inferencing operations and for providing inferenced data, including data-to-data translations. The conditional diffusion model may be stored (partially or wholly) in one or both of data storage 701 and 705 in inference and/or training logic 715 as depicted in FIGS. 7A and 7B. Training and deployment of the conditional diffusion model may be performed as depicted in FIG. 8 and described herein. Distribution of the conditional diffusion model may be performed using one or more servers in a data center 900 as depicted in FIG. 9 and described herein.

What is claimed is:

1. A method, comprising:
at a device:
accessing a pair of images in training data, wherein the pair of images includes a clean version of an image and a degraded version of the same image;
computing one or more diffusion bridges that incrementally transform the degraded version of the image to the clean version of the image; and
using the degraded version of the image, the clean version of the image, and the one or more diffusion bridges to train a conditional diffusion model to improve degraded images, such that, given any input image, the conditional diffusion model outputs a corresponding image with improved quality.

2. The method of claim 1, wherein the degraded version of the image includes more blurring than the clean version of the image, such that the conditional diffusion model is trained to reduce blur in a given image.

3. The method of claim 1, wherein the clean version of the image is a complete image and the degraded version of the image includes areas that are missing, such that that the conditional diffusion model is trained to complete missing areas of a given image.

4. The method of claim 1, wherein the conditional diffusion model is trained to improve a quality of a given photograph, wherein the given photograph has at least one of blurring, low resolution, or missing areas.

5. The method of claim 1, wherein the one or more diffusion bridges train a score function to improve degraded images.

6. A method, comprising:
at a device:
computing one or more diffusion bridges between a first version of data and a second version of the data; and
using the one or more diffusion bridges to train a conditional diffusion model to perform data-to-data translation.

7. The method of claim 6, wherein the first version of the data is a degraded version of the data and the second version of the data is a clean target version of the data.

8. The method of claim 7, wherein the data-to-data translation is a data restoration task.

9. The method of claim 6, wherein the data is an image.

10. The method of claim 9, wherein the first version of the image is a degraded version of the image and the second version of the image is a clean target version of the image.

11. The method of claim 10, wherein the degraded version of the image has a lower resolution than the clean target version of the image.

12. The method of claim 10, wherein the degraded version of the image is a corrupted version of the clean target version of the image.

13. The method of claim 10, wherein the degraded version of the image includes more blurring than the clean target version of the image.

14. The method of claim 10, wherein the degraded version of the image is captured by a camera.

15. The method of claim 14, wherein the camera is a component of an autonomous driving system.

16. The method of claim 6, wherein the one or more diffusion bridges are tractable, interpretable, and efficient.

17. The method of claim 6, wherein the one or more diffusion bridges between the first version of the data and the second version of the data are nonlinear.

18. The method of claim 6, wherein the one or more diffusion bridges correspond to one or more time steps existing between the first version of the data and the second version of the data.

19. The method of claim 6, wherein the one or more diffusion bridges train a score function to perform the data-to-data translation.

20. The method of claim 6, wherein the conditional diffusion model is trained to perform the data-to-data translation for a data compression application.

21. The method of claim 6, wherein the conditional diffusion model is trained to perform the data-to-data translation for a robotics application.

22. The method of claim 6, wherein the conditional diffusion model is trained to perform the data-to-data translation for an autonomous driving application.

23. A system, comprising:
a non-transitory memory storage comprising instructions; and
one or more processors in communication with the memory, wherein the one or more processors execute the instructions to:
compute one or more diffusion bridges between a first version of data and a second version of the data; and
use the one or more diffusion bridges to train a conditional diffusion model to perform data-to-data translation.

24. The system of claim 23, wherein the first version of the data is a degraded version of the data and the second version of the data is a clean target version of the data.

25. The system of claim 23, wherein the data-to-data translation is a data restoration task.

26. The system of claim 23, wherein the data is an image.

27. The system of claim 26, wherein the first version of the image is a degraded version of the image and the second version of the image is a clean target version of the image.

28. The system of claim 27, wherein at least one of:
the degraded version of the image has a lower resolution than the clean target version of the image,
the degraded version of the image is a corrupted version of the clean target version of the image, or
the degraded version of the image includes more blurring than the clean target version of the image.

29. The system of claim 27, wherein the degraded version of the image is captured by a camera.

30. The system of claim 29, wherein the camera is a component of an autonomous driving system.

31. The system of claim 23, wherein the one or more diffusion bridges are tractable, interpretable, and efficient.

32. The system of claim 23, wherein the one or more diffusion bridges between the first version of the data and the second version of the data are nonlinear.

33. The system of claim 23, wherein the one or more diffusion bridges correspond to one or more time steps existing between the first version of the data and the second version of the data.

34. The system of claim 23, wherein the one or more diffusion bridges train a score function to perform data restoration.

35. The system of claim 23, wherein the conditional diffusion model is trained to perform the data restoration for at least one of:
a data compression application,
a robotics application, or
an autonomous driving application.

36. A non-transitory computer-readable media storing computer instructions which when executed by one or more processors of a device cause the device to:
compute one or more diffusion bridges between a first version of data and a second version of the data; and
use the one or more diffusion bridges to train a conditional diffusion model to perform data-to-data translation.

37. The non-transitory computer-readable media of claim 36, wherein the one or more diffusion bridges correspond to one or more time steps existing between the first version of the data and the second version of the data.

38. The non-transitory computer-readable media of claim 36, wherein the one or more diffusion bridges train a score function to perform data restoration.
